(19) United States
(12) Patent Application Publication
(10) Pub. No.: US 2026/0100403 A1
(43) Pub. Date: Apr. 9, 2026

(54) MANDREL FOR WINDING ELECTRODE OF SECONDARY BATTERY

(71) Applicant: Samsung SDI Co., Ltd., Yongin-si (KR)

(72) Inventor: Ju Hyung Lee, Suwon-si (KR)

(73) Assignee: Samsung SDI Co., Ltd., Yongin-si (KR)

(21) Appl. No.: 19/348,919

(22) Filed: Oct. 3, 2025

(30) Foreign Application Priority Data
Oct. 8, 2024 (KR) 10-2024-0136272

(51) Int. Cl. H01M 10/04

(52) U.S. Cl. CPC H01M 10/0409; H01M 10/0431

(57) ABSTRACT

The present disclosure relates to a mandrel for winding an electrode of a secondary battery, and provides a mandrel for winding an electrode of a secondary battery including a first mandrel member comprising a plurality of exterior faces including longitudinal side surfaces and a first surface, wherein a first hollow portion is provided between the longitudinal side surfaces, and a second mandrel member spaced apart from the first mandrel member and comprising a plurality of exterior faces including second longitudinal side surfaces and a second surface, wherein a second hollow portion is provided between the second longitudinal side surfaces.

### CROSS-REFERENCE TO RELATED APPLICATIONS

This present application claims priority to and the benefit under 35 U.S.C. § 119(a)-(d) of Korean Patent Application No. 10-2024-0136272, filed on Oct. 8, 2024, in the Korean Intellectual Property Office, the entire disclosure of which is incorporated herein by reference.

### FIELD

The present disclosure relates to a mandrel for winding an electrode of a secondary battery.

### BACKGROUND

Generally, the demand for secondary batteries with high energy density and high capacity is rapidly increasing with the rapid spread of electronic devices using batteries, such as mobile phones, notebook computers, electric vehicles, and the like.

A secondary battery has a form in which an electrode assembly is formed by winding or stacking a positive electrode, a negative electrode, and a separator interposed between the positive electrode and the negative electrode, and is sealed in a can, pouch, or the like along with an electrolyte.

The herein-described information disclosed in the technology that forms the background of the present disclosure is provided to improve understanding of the background of the present disclosure, and thus may include information that does not constitute the related art.

### SUMMARY

The present disclosure is directed to providing a mandrel for winding an electrode of a secondary battery capable of eliminating static electricity.

These and other aspects and features of the present disclosure will be described in or will be apparent from the following description of some embodiments of the present disclosure.

A mandrel for winding an electrode of a secondary battery according to one embodiment of the present disclosure for solving the herein technical problem includes a first mandrel member comprising a plurality of exterior faces including longitudinal side surfaces and a first surface, wherein a first hollow portion is provided between the longitudinal side surfaces, and a second mandrel member spaced apart from the first mandrel member comprising a plurality of exterior faces including second longitudinal side surfaces and a second surface facing the first surface, wherein a second hollow portion is provided between the second longitudinal side surfaces.

The first mandrel member may include a first flat surface intersecting the first surface and including a first through hole portion and a second flat surface intersecting the first surface, spaced apart from and facing the first flat surface, and including a second through hole portion.

The first mandrel member may include a first tip portion protruding from the first flat surface and accommodated in the first hollow portion.

The first tip portion may not be in contact with the second flat surface and may have a width that becomes smaller toward an end portion.

The first mandrel member may further include a second tip portion protruding from the second flat surface and accommodated in the first hollow portion.

The second tip portion may not be in contact with the first flat surface and may have a width that becomes smaller toward an end portion.

The first tip portion may comprise a plurality of first tip portions, the second tip portion may comprise a plurality of second tip portions, and the plurality of first tip portions and second tip portions may be disposed to be spaced apart from each other along a longitudinal direction of the first mandrel member.

The plurality of first tip portions and second tip portions may be disposed in an alternating manner.

The first mandrel member may include a first inclined surface extending in an inclined manner from the first flat surface and a second inclined surface extending in an inclined manner from the second flat surface and connected to the first inclined surface.

An interior angle between the first flat surface and the first inclined surface may form an obtuse angle, and an interior angle between the second flat surface and the second inclined surface may form an obtuse angle.

The second mandrel member may include a third flat surface intersecting the second surface and including a third through hole portion and a fourth flat surface intersecting the second surface, spaced apart from and facing the third flat surface, and including a fourth through hole portion.

The second mandrel member may include a third tip portion protruding from the third flat surface and accommodated in the second hollow portion.

The third tip portion may not be in contact with the fourth flat surface and may have a width that becomes smaller toward an end portion.

The second mandrel member may further include a fourth tip portion protruding from the fourth flat surface and accommodated in the second hollow portion. The fourth tip portion may not be in contact with the third flat surface and may have a width that becomes smaller toward an end portion.

The third tip portion may comprise a plurality of third tip portions, the fourth tip portion may comprise a plurality of third tip portions, and the plurality of third tip portions and fourth tip portions may be disposed to be spaced apart from each other along a longitudinal direction of the second mandrel member.

The plurality of third tip portions and fourth tip portions may be disposed in an alternating manner.

The second mandrel member may include a third inclined surface extending in an inclined manner from the third flat surface and a fourth inclined surface extending in an inclined manner from the fourth flat surface and connected to the third inclined surface.

An interior angle between the third flat surface and the third inclined surface may form an obtuse angle, and an interior angle between the fourth flat surface and the fourth inclined surface may form an obtuse angle.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a plan perspective view schematically illustrating a mandrel for winding an electrode of a secondary battery according to one embodiment of the present disclosure;

FIG. 2 is a bottom perspective view schematically illustrating the mandrel for winding an electrode of a secondary battery according to one embodiment of the present disclosure;

FIG. 3 is a front perspective view schematically illustrating the mandrel for winding an electrode of a secondary battery according to one embodiment of the present disclosure;

FIG. 4 is a front perspective view of the mandrel for winding an electrode of a secondary battery in FIG. 3 viewed from another direction;

FIG. 5 is a front view schematically illustrating the mandrel for winding an electrode of a secondary battery according to one embodiment of the present disclosure;

FIG. 6 is a side surface view schematically illustrating a first mandrel member according to one embodiment of the present disclosure;

FIG. 7 is a side surface view schematically illustrating a second mandrel member according to one embodiment of the present disclosure; and

FIGS. 8 to 10 are views schematically illustrating various embodiments of a first tip portion, a second tip portion, a third tip portion, and a fourth tip portion according to one embodiment of the present disclosure.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C; A and B; A and C; B and C; or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the other part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

A winding-type electrode assembly is completed by winding an electrode plate around a mandrel, which is a winding center, and then separating the mandrel. The mandrel should be separated from the electrode assembly after the winding is completed, and the electrode assembly should not be damaged when separated. Accordingly, it is necessary to provide a mandrel in which an electrode assembly can be smoothly separated and discharged.

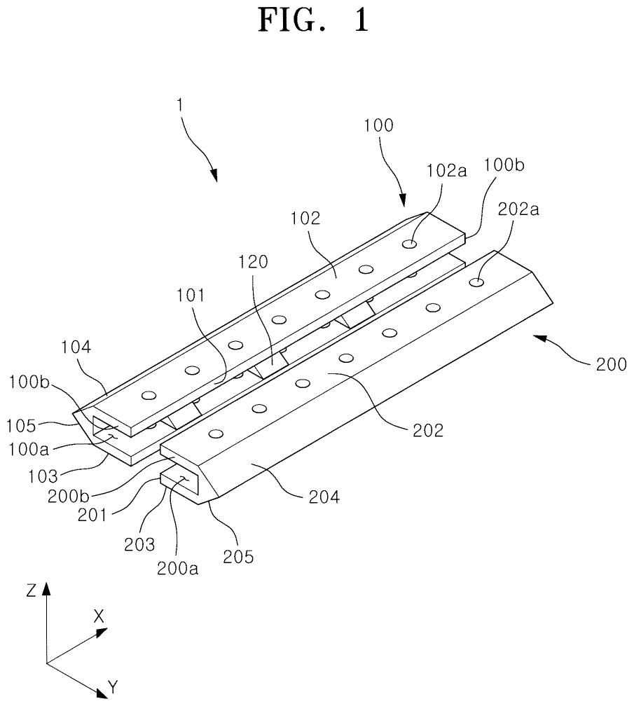

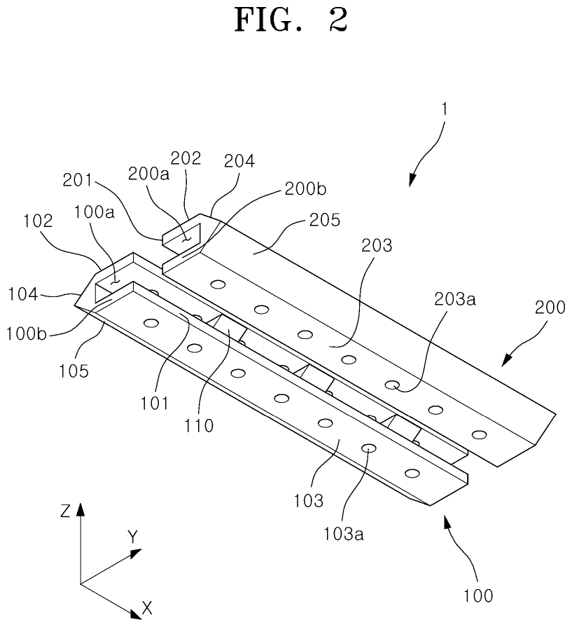

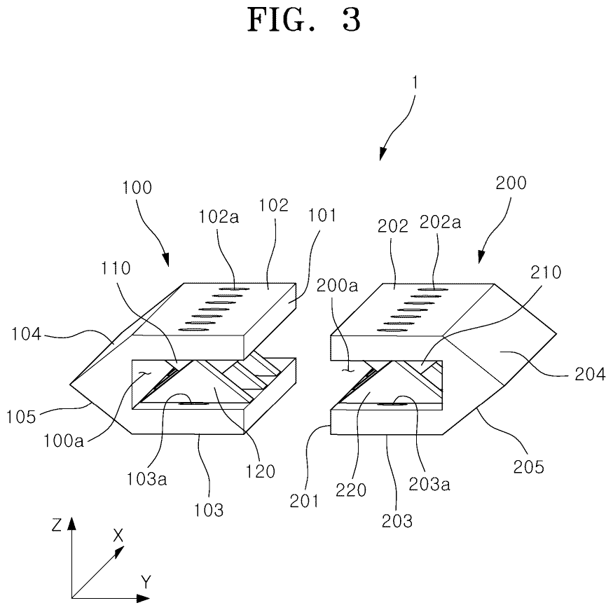

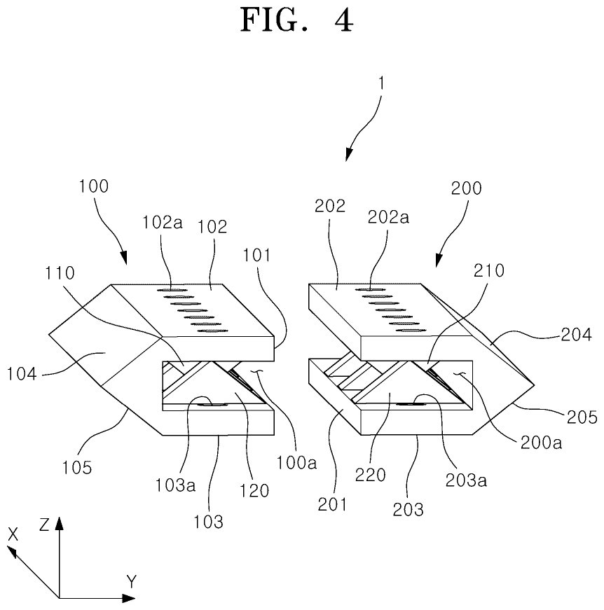

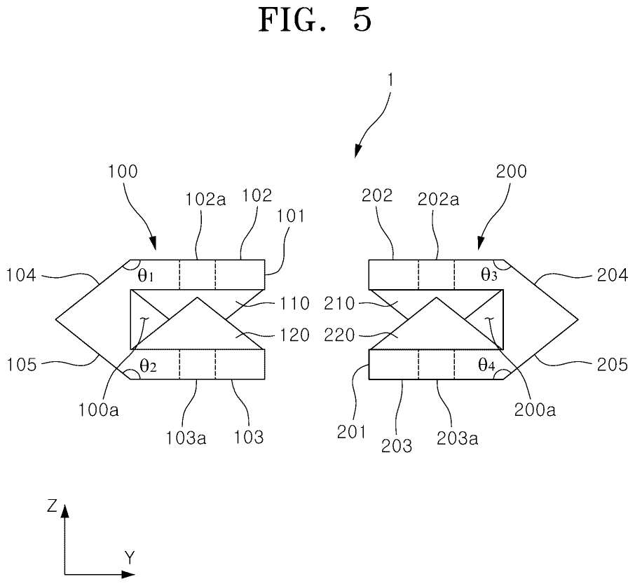

FIG. 1 is a plan perspective view schematically illustrating a mandrel for winding an electrode of a secondary battery according to one embodiment of the present disclosure, FIG. 2 is a bottom perspective view schematically illustrating the mandrel for winding an electrode of a secondary battery according to one embodiment of the present disclosure, FIG. 3 is a front perspective view schematically illustrating the mandrel for winding an electrode of a secondary battery according to one embodiment of the present disclosure, FIG. 4 is a front perspective view of the mandrel for winding an electrode of a secondary battery in FIG. 3 viewed from another direction, and FIG. 5 is a front view schematically illustrating the mandrel for winding an electrode of a secondary battery according to one embodiment of the present disclosure.

Referring to FIGS. 1 to 5, a mandrel 1 for winding an electrode of a secondary battery according to an embodiment of the present disclosure may include a first mandrel member 100 and a second mandrel member 200.

The mandrel 1 for winding an electrode of a secondary battery according to the embodiment may wind an electrode of a secondary battery. The mandrel 1 for winding an electrode of a secondary battery may be used to manufacture an electrode assembly. The secondary battery may function as a unit structure which stores and supplies power in a battery module or battery pack.

The secondary battery may be a cylindrical battery such as a lithium-ion secondary battery, but is not limited thereto, and in some embodiments, the secondary battery may be a lithium polymer battery, a prismatic battery, or a pouch-type battery.

The electrode assembly may function as a unit structure which performs charging and discharging operations of power in the secondary battery. The electrode assembly may be formed to have a jelly roll shape wound around a winding axis in a clockwise direction or counterclockwise direction in a state in which a positive electrode, a separator, and a negative electrode are stacked.

The first mandrel member 100 and the second mandrel member 200 are disposed to be spaced a set distance apart from each other, and an end portion of an electrode plate may be inserted between the first mandrel member 100 and the second mandrel member 200.

When the first mandrel member 100 and the second mandrel member 200 are rotated together in a state in which the positive electrode, the negative electrode, and the separator are interposed between the first mandrel member 100 and the second mandrel member 200, the electrode plate may be wound around an outer side surface of the mandrel 1 for winding an electrode of a secondary battery according to the embodiment.

A first direction to be described herein is parallel to an X-axis based on FIGS. 1 and 2 and may mean a longitudinal direction of the first mandrel member 100 and the second mandrel member 200. A second direction is parallel to a Y-axis based on FIGS. 1 and 2 and may mean a width direction of the first mandrel member 100 and the second mandrel member 200. A third direction is parallel to a Z-axis based on FIGS. 1 and 2 and may mean a height direction of the first mandrel member 100 and the second mandrel member 200.

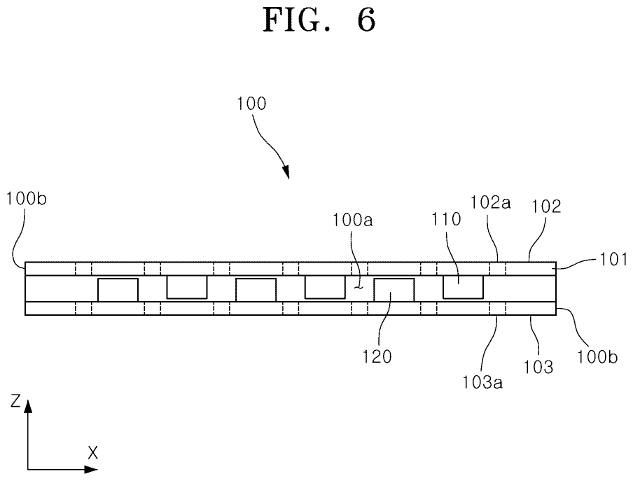

FIG. 6 is a side surface view schematically illustrating the first mandrel member according to one embodiment of the present disclosure.

Referring to FIGS. 1 to 6, the first mandrel member 100 according to the embodiment may be formed in a shape in which both longitudinal side surfaces 100b parallel to the first direction are open and a first surface 101 disposed orthogonally to both longitudinal side surfaces 100b is open.

The first surface 101 may form an exterior of one side (right side based on FIG. 1) of the first mandrel member 100. The first surface 101 of the first mandrel member 100 may be disposed toward a direction in which the second mandrel member 200 is located.

The first mandrel member 100 may be formed in a structure in which both longitudinal side surfaces 100b and the first surface 101 are connected continuously and communicate with each other.

The first mandrel member 100 may be formed in a hollow shape with an empty interior. A first hollow portion 100a may be provided in the first mandrel member 100. The first hollow portion 100a may be referred to as an inner space of the first mandrel member 100.

The first mandrel member 100 may be formed in a structure in which both longitudinal side surfaces 100b, the first surface 101, and the first hollow portion 100a are connected continuously and communicate with each other.

The first mandrel member 100 according to the embodiment may include a first flat surface 102 and a second flat surface 103.

The first flat surface 102 may form an exterior of an upper side (based on FIG. 1) of the first mandrel member 100. The first flat surface 102 may be disposed to intersect the first surface 101. The first flat surface 102 may have a rectangular plate shape in which a length parallel to the second direction is shorter than a length parallel to the first direction.

The first flat surface 102 may include a first through hole portion 102a. The first through hole portion 102a may be formed through the first flat surface 102 in a thickness direction. The first through hole portion 102a may be formed through the first flat surface 102 in a direction parallel to the third direction.

A plurality of first through hole portions 102a may be disposed to be spaced apart from each other along a longitudinal direction of the first flat surface 102 parallel to the first direction.

Ions which are generated by a first tip portion 110 and/or a second tip portion 120 and eliminate static electricity may be discharged to an electrostatic target through the first through hole portion 102a in the first hollow portion 100a.

The second flat surface 103 may form an exterior of a lower side (based on FIG. 1) of the first mandrel member 100. The second flat surface 103 may be disposed to intersect the first surface 101. The second flat surface 103 may have a rectangular plate shape in which a length parallel to the second direction is shorter than a length parallel to the first direction.

The second flat surface 103 may be spaced apart from and face the first flat surface 102. The second flat surface 103 may be disposed to be spaced apart from the first flat surface 102 along a direction opposite to the third direction.

The first flat surface 102 and the second flat surface 103 may be disposed to face each other. The first flat surface 102 and the second flat surface 103 may be disposed parallel to each other.

Areas of the first flat surface 102 and the second flat surface 103 may be the same. The first flat surface 102 and the second flat surface 103 may have the same length parallel to the first direction and the same length parallel to the second direction.

The lengths of the first flat surface 102 and the second flat surface 103 parallel to the first direction and a length of the first surface 101 parallel to the first direction may be the same. An area of the first surface 101 may be smaller than the areas of the first flat surface 102 and the second flat surface 103.

The second flat surface 103 may include a second through hole portion 103a. The second through hole portion 103a may be formed through the second flat surface 103 in a thickness direction. The second through hole portion 103a may be formed through the second flat surface 103 in a direction parallel to the third direction.

A plurality of second through hole portions 103a may be disposed to be spaced apart from each other along the longitudinal direction of the first mandrel member 100 parallel to the first direction. In detail, the plurality of second through hole portions 103a may be disposed to be spaced apart from each other along a longitudinal direction of the second flat surface 103.

Ions which are generated by the first tip portion 110 and/or the second tip portion 120 and eliminate static electricity may be discharged to an electrostatic target through the second through hole portion 103a in the first hollow portion 100a.

The second through hole portion 103a according to the embodiment may be disposed at a position corresponding to the first through hole portion 102a. In detail, a through axis of the first through hole portion 102a and a through axis of the second through hole portion 103a may be disposed on a coaxial line to coincide with each other. In another embodiment, the through axis of the first through hole portion 102a and the through axis of the second through hole portion 103a may be disposed in parallel so as not to coincide with each other.

The first mandrel member 100 according to the embodiment may include the first tip portion 110.

The first tip portion 110 may be provided on the first flat surface 102 and may protrude from the first flat surface 102. The first tip portion 110 may extend from the first flat surface 102 in the direction opposite to the third direction in which the second flat surface 103 is located. The first tip portion 110 may be accommodated in the first hollow portion 100a.

A plurality of first tip portions 110 may be disposed to be spaced apart from each other along the longitudinal direction of the first mandrel member 100 parallel to the first direction. The plurality of first tip portions 110 may be disposed to be spaced apart from each other along the longitudinal direction of the first flat surface 102.

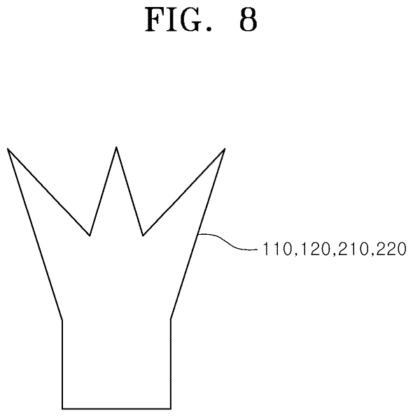

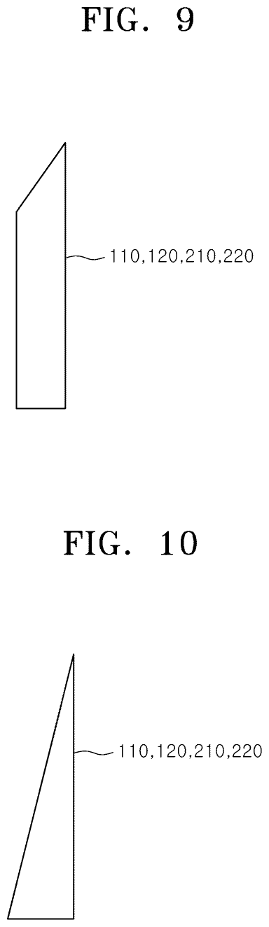

The first tip portion 110 may not be in contact with the second flat surface 103. The first tip portion 110 may have a shape whose width becomes smaller toward an end portion. For example, the first tip portion 110 may have a triangular shape whose width becomes smaller toward an end portion where a vertex is located. However, the present disclosure is not limited thereto, and the first tip portion 110 may have a plurality of end portions as shown in FIG. 8 in addition to the triangle shown in FIGS. 3 and 4, or may be designed to have various shapes as shown in FIGS. 9 and 10, when having a pointed end shape.

The first tip portion 110 according to the embodiment may include an electrically conductive material and may be electrically connected to a power source. Since a high voltage generated from the power source may be applied to the first tip portion 110, a corona discharge may occur at the end portion of the first tip portion 110. Accordingly, since the air surrounding the first tip portion 110 is changed into ions, the first mandrel member 100 may have a function of eliminating static electricity.

The first mandrel member 100 according to the embodiment may further include the second tip portion 120.

The second tip portion 120 may be provided on the second flat surface 103 and may protrude from the second flat surface 103. The second tip portion 120 may extend from the second flat surface 103 in the third direction in which the second flat surface 103 is located. The second tip portion 120 may be accommodated in the first hollow portion 100a.

The second tip portion 120 may not be in contact with the first flat surface 102. The second tip portion 120 may have a shape whose width becomes smaller toward an end portion. For example, the second tip portion 120 may have a triangular shape whose width becomes smaller toward an end portion where a vertex is located. However, the present disclosure is not limited thereto, and the second tip portion 120 may have a plurality of end portions as shown in FIG. 8 in addition to the triangle shown in FIGS. 3 and 4, or may be designed to have various shapes as shown in FIGS. 9 and 10, when having a pointed end shape.

The second tip portion 120 according to the embodiment may include an electrically conductive material and may be electrically connected to the power source. Since a high voltage generated from the power source may be applied to the second tip portion 120, a corona discharge may occur at the end portion of the second tip portion 120. Accordingly, since the air surrounding the second tip portion 120 is changed into ions, the first mandrel member 100 may have a function of eliminating static electricity.

A plurality of second tip portions 120 may be disposed to be spaced apart from each other along the longitudinal direction of the first mandrel member 100 parallel to the first direction. The plurality of second tip portions 120 may be disposed to be spaced apart from each other along the longitudinal direction of the second flat surface 103.

The first tip portion 110 and the second tip portion 120 according to the embodiment may be disposed in an alternating manner. The first tip portion 110 and the second tip portion 120 may be spaced apart from each other and may be disposed in an alternating manner along the longitudinal direction of the first mandrel member 100 parallel to the first direction.

The first mandrel member 100 according to the embodiment may include a first inclined surface 104 and a second inclined surface 105.

The first inclined surface 104 and the second inclined surface 105 may have shapes protruding in the width direction of the first mandrel member 100.

The first inclined surface 104 may extend from the first flat surface 102. The first inclined surface 104 may extend in an inclined manner at a set angle from the first flat surface 102 toward a direction opposite to the second direction. An interior angle θ₁ of the first flat surface 102 and the first inclined surface 104 may form an obtuse angle.

The second inclined surface 105 may extend from the second flat surface 103. The second inclined surface 105 may extend in an inclined manner at a set angle from the second flat surface 103 toward the direction opposite to the second direction. An interior angle θ₂ of the second flat surface 103 and the second inclined surface 105 may form an obtuse angle.

The interior angle θ₁ of the first flat surface 102 and the first inclined surface 104 and the interior angle θ₂ of the second flat surface 103 and the second inclined surface 105 may be the same.

The second mandrel member 200 according to the embodiment may be spaced apart from the first mandrel member 100. The second mandrel member 200 may be disposed to be spaced apart from the first mandrel member 100 along the second direction.

The first mandrel member 100 and the second mandrel member 200 may be disposed in parallel in the first direction. The first mandrel member 100 and the second mandrel member 200 may be disposed parallel to each other.

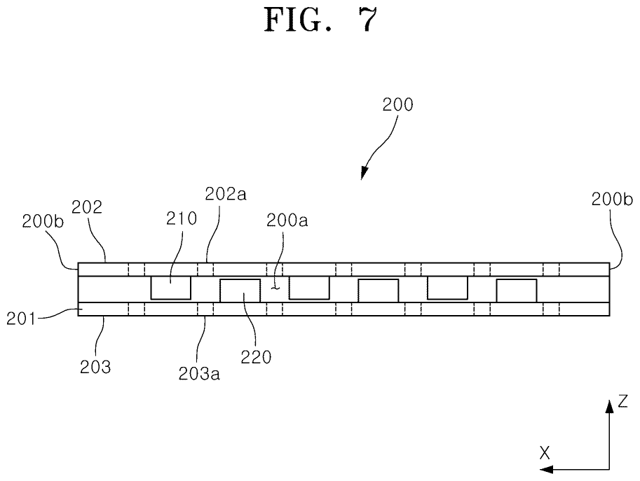

FIG. 7 is a side surface view schematically illustrating a second mandrel member according to one embodiment of the present disclosure.

Referring to FIGS. 1 to 5, and 7, the second mandrel member 200 according to the embodiment may be formed in a shape in which both longitudinal side surfaces 200b parallel to the first direction are open and a second surface 201 disposed orthogonally to both longitudinal side surfaces 200b is open.

The second surface 201 may form an exterior of one side (left side based on FIG. 1) of the second mandrel member 200. The second surface 201 of the second mandrel member 200 may be disposed toward a direction in which the first mandrel member 100 is located. The first surface 101 of the first mandrel member 100 and the second surface 201 of the second mandrel member 200 may be disposed to face each other.

The second mandrel member 200 may be formed in a structure in which both longitudinal side surfaces 200b and the second surface 201 are connected without being disconnected and communicate with each other.

The second mandrel member 200 may be formed in a hollow shape with an empty interior. A second hollow portion 200a may be provided in the second mandrel member 200. The second hollow portion 200a may be referred to as an inner space of the second mandrel member 200.

The second mandrel member 200 may be formed in a structure in which both longitudinal side surfaces 200b, the second surface 201, and the second hollow portion 200a are connected continuously and communicate with each other.

The second mandrel member 200 according to the embodiment may include a third flat surface 202 and a fourth flat surface 203.

The third flat surface 202 may form an exterior of an upper side (based on FIG. 1) of the second mandrel member 200. The third flat surface 202 may be disposed to intersect the second surface 201. The third flat surface 202 may have a rectangular plate shape in which a length parallel to the second direction is shorter than a length parallel to the first direction.

The third flat surface 202 may include a third through hole portion 202a. The third through hole portion 202a may be formed through the third flat surface 202 in a thickness direction. The third through hole portion 202a may be formed through the third flat surface 202 in a direction parallel to the third direction.

A plurality of third through hole portions 202a may be disposed to be spaced apart from each other along a longitudinal direction of the third flat surface 202 parallel to the first direction.

Ions which are generated by a third tip portion 210 and/or a fourth tip portion 220 and eliminate static electricity may be discharged to an electrostatic target through the third through hole portion 202a in the second hollow portion 200a.

The fourth flat surface 203 may form an exterior of a lower side (based on FIG. 1) of the second mandrel member 200. The fourth flat surface 203 may be disposed to intersect the second surface 201. The fourth flat surface 203 may have a rectangular plate shape in which a length parallel to the second direction is shorter than a length parallel to the first direction.

The fourth flat surface 203 may be spaced apart from and face the third flat surface 202. The fourth flat surface 203 may be disposed to be spaced apart from the third flat surface 202 along the direction opposite to the third direction.

The third flat surface 202 and the fourth flat surface 203 may be disposed to face each other. The third flat surface 202 and the fourth flat surface 203 may be disposed parallel to each other.

Areas of the third flat surface 202 and the fourth flat surface 203 may be the same. The third flat surface 202 and the fourth flat surface 203 may have the same length parallel to the first direction and the same length parallel to the second direction.

The lengths of the third flat surface 202 and the fourth flat surface 203 parallel to the first direction and a length of the second surface 201 parallel to the first direction may be the same. An area of the second surface 201 may be smaller than the areas of the third flat surface 202 and the fourth flat surface 203.

The fourth flat surface 203 may include a fourth through hole portion 203a. The fourth through hole portion 203a may be formed through the fourth flat surface 203 in a thickness direction. The fourth through hole portion 203a may be formed through the fourth flat surface 203 in a direction parallel to the third direction.

A plurality of fourth through hole portions 203a may be disposed to be spaced apart from each other along the longitudinal direction of the second mandrel member 200 parallel to the first direction. In detail, the plurality of fourth through hole portions 203a may be disposed to be spaced apart from each other along a longitudinal direction of the fourth flat surface 203.

Ions which are generated by the third tip portion 210 and/or the fourth tip portion 220 and eliminate static electricity may be discharged to an electrostatic target through the fourth through hole portion 203a in the second hollow portion 200a.

The fourth through hole portion 203a according to the embodiment may be disposed at a position corresponding to the third through hole portion 202a. In detail, a through axis of the third through hole portion 202a and a through axis of the fourth through hole portion 203a may be disposed on a coaxial line to coincide with each other. In another embodiment, the through axis of the third through hole portion 202a and the through axis of the fourth through hole portion 203a may be disposed in parallel so as not to coincide with each other.

The second mandrel member 200 according to the embodiment may include the third tip portion 210.

The third tip portion 210 may be provided on the third flat surface 202 and may protrude from the third flat surface 202. The third tip portion 210 may extend from the third flat surface 202 in the direction opposite to the third direction in which the fourth flat surface 203 is located. The third tip portion 210 may be accommodated in the second hollow portion 200a.

A plurality of third tip portions 210 may be disposed to be spaced apart from each other along the longitudinal direction of the second mandrel member 200 parallel to the first direction. The plurality of third tip portions 210 may be disposed to be spaced apart from each other along the longitudinal direction of the third flat surface 202.

The third tip portion 210 may not be in contact with the fourth flat surface 203. The third tip portion 210 may have a shape whose width becomes smaller toward an end portion. For example, the third tip portion 210 may have a triangular shape whose width becomes smaller toward an end portion where a vertex is located. However, the present disclosure is not limited thereto, and the third tip portion 210 may have a plurality of end portions as shown in FIG. 8 in addition to the triangle shown in FIGS. 3 and 4, or may be designed to have various shapes as shown in FIGS. 9 and 10, when having a pointed end shape.

The third tip portion 210 according to the embodiment may include an electrically conductive material and may be electrically connected to a power source. Since a high voltage generated from the power source may be applied to the third tip portion 210, a corona discharge may occur at the end portion of the third tip portion 210. Accordingly, since the air surrounding the third tip portion 210 is changed into ions, the second mandrel member 200 may have a function of eliminating static electricity.

The second mandrel member 200 according to the embodiment may further include the fourth tip portion 220.

The fourth tip portion 220 may be provided on the fourth flat surface 203 and may protrude from the fourth flat surface 203. The fourth tip portion 220 may extend from the fourth flat surface 203 in the third direction in which the fourth flat surface 203 is located. The fourth tip portion 220 may be accommodated in the second hollow portion 200a.

The fourth tip portion 220 may not be in contact with the third flat surface 202. The fourth tip portion 220 may have a shape whose width becomes smaller toward an end portion. For example, the fourth tip portion 220 may have a triangular shape whose width becomes smaller toward an end portion where a vertex is located. However, the present disclosure is not limited thereto, and the fourth tip portion 220 may have a plurality of end portions as shown in FIG. 8 in addition to the triangle shown in FIGS. 3 and 4, or may be designed to have various shapes as shown in FIGS. 9 and 10, when having a pointed end shape.

The fourth tip portion 220 according to the embodiment may include an electrically conductive material and be electrically connected to the power source. Since a high voltage generated from the power source may be applied to the fourth tip portion 220, a corona discharge may occur at the end portion of the fourth tip portion 220. Accordingly, since the air surrounding the fourth tip portion 220 is changed into ions, the second mandrel member 200 may have a function of eliminating static electricity.

A plurality of fourth tip portions 220 may be disposed to be spaced apart from each other along the longitudinal direction of the second mandrel member 200 parallel to the first direction. The plurality of fourth tip portions 220 may be disposed to be spaced apart from each other along the longitudinal direction of the fourth flat surface 203.

The third tip portion 210 and the fourth tip portion 220 according to the embodiment may be disposed in an alternating manner. The third tip portion 210 and the fourth tip portion 220 may be spaced apart from each other and may be disposed in an alternating manner along the longitudinal direction of the second mandrel member 200 parallel to the first direction.

The second mandrel member 200 according to the embodiment may include a third inclined surface 204 and a fourth inclined surface 205.

The third inclined surface 204 and the fourth inclined surface 205 may have shapes protruding in the width direction of the second mandrel member 200.

The third inclined surface 204 may extend from the third flat surface 202. The third inclined surface 204 may extend in an inclined manner at a set angle from the third flat surface 202 toward the second direction. An interior angle θ₃ of the third flat surface 202 and the third inclined surface 204 may form an obtuse angle.

The fourth inclined surface 205 may extend from the fourth flat surface 203. The fourth inclined surface 205 may extend in an inclined manner at a set angle from the fourth flat surface 203 toward the second direction. An interior angle θ₄ of the fourth flat surface 203 and the fourth inclined surface 205 may form an obtuse angle. The interior angle θ₃ of the third flat surface 202 and the third inclined surface 204 and the interior angle θ₄ of the fourth flat surface 203 and the fourth inclined surface 205 may be the same.

According to one embodiment of the present disclosure, as ions which are generated by a first tip portion and a second tip portion of a first mandrel member and a third tip portion and a fourth tip portion of a second mandrel member and eliminate static electricity are discharged through a first through hole portion and a second through hole portion of the first mandrel member and a third through hole portion and a fourth through hole portion of the second mandrel member, the entire mandrel for winding an electrode of a secondary battery can have a function of eliminating static electricity.

However, the effects obtainable through the present disclosure are not limited to the herein effects, and other technical effects that are not mentioned will be clearly understood by those skilled in the art from the following description of the present disclosure.

While the present disclosure has been described with reference to some example embodiments shown in the drawings, these embodiments are merely illustrative and it is to be understood that various modifications and equivalent other embodiments can be derived by those skilled in the art on the basis of the embodiments. Therefore, the technical scope of the present disclosure should be defined by the claims.

What is claimed is:

1. A mandrel for winding an electrode of a secondary battery, comprising:
a first mandrel member comprising a plurality of exterior faces including longitudinal side surfaces and a first surface, wherein a first hollow portion is provided between the longitudinal side surfaces; and
a second mandrel member spaced apart from the first mandrel member, the second mandrel comprising a plurality of exterior faces including second longitudinal side surfaces and a second surface facing the first surface, wherein a second hollow portion is provided between the second longitudinal side surfaces.

2. The mandrel of claim 1, wherein the first mandrel member includes:
a first flat surface intersecting the first surface and including a first through hole portion; and
a second flat surface intersecting the first surface, spaced apart from and facing the first flat surface, and including a second through hole portion.

3. The mandrel of claim 2, wherein the first mandrel member includes a first tip portion protruding from the first flat surface and accommodated in the first hollow portion.

4. The mandrel of claim 3, wherein the first tip portion is not in contact with the second flat surface and has a width that becomes smaller toward an end portion.

5. The mandrel of claim 3, wherein the first mandrel member further includes a second tip portion protruding from the second flat surface and accommodated in the first hollow portion.

6. The mandrel of claim 5, wherein the second tip portion is not in contact with the first flat surface and has a width that becomes smaller toward an end portion.

7. The mandrel of claim 5, wherein the first tip portion comprises a plurality of first tip portions, the second tip portion comprises a plurality of second tip portions, and the plurality of first and second tip portions are disposed to be spaced apart from each other along a longitudinal direction of the first mandrel member.

8. The mandrel of claim 7, wherein the plurality of first tip portions and second tip portions are disposed in an alternating manner.

9. The mandrel of claim 2, wherein the first mandrel member includes:
a first inclined surface extending in an inclined manner from the first flat surface; and
a second inclined surface extending in an inclined manner from the second flat surface and connected to the first inclined surface.

10. The mandrel of claim 9, wherein:
an interior angle between the first flat surface and the first inclined surface forms an obtuse angle; and
an interior angle between the second flat surface and the second inclined surface forms an obtuse angle.

11. The mandrel of claim 1, wherein the second mandrel member includes:
a third flat surface intersecting the second surface and including a third through hole portion; and
a fourth flat surface intersecting the second surface, spaced apart from and facing the third flat surface, and including a fourth through hole portion.

12. The mandrel of claim 11, wherein the second mandrel member includes a third tip portion protruding from the third flat surface and accommodated in the second hollow portion.

13. The mandrel of claim 12, wherein the third tip portion is not in contact with the fourth flat surface and has a width that becomes smaller toward an end portion.

14. The mandrel of claim 12, wherein the second mandrel member further includes a fourth tip portion protruding from the fourth flat surface and accommodated in the second hollow portion.

15. The mandrel of claim 14, wherein the fourth tip portion is not in contact with the third flat surface and has a width that becomes smaller toward an end portion.

16. The mandrel of claim 14, wherein the third tip portion comprises a plurality of third tip portions, the fourth tip portion comprises a plurality of fourth tip portions, and the plurality of third and fourth tip portions are disposed to be spaced apart from each other along a longitudinal direction of the second mandrel member.

17. The mandrel of claim 16, wherein the plurality of third tip portions and fourth tip portions are disposed in an alternating manner.

18. The mandrel of claim 11, wherein the second mandrel member includes:
a third inclined surface extending in an inclined manner from the third flat surface; and
a fourth inclined surface extending in an inclined manner from the fourth flat surface and connected to the third inclined surface.

19. The mandrel of claim 18, wherein:
an interior angle between the third flat surface and the third inclined surface forms an obtuse angle; and
an interior angle between the fourth flat surface and the fourth inclined surface forms an obtuse angle.
